(19) United States
(12) Patent Application Publication
(10) Pub. No.: US 2003/0191978 A1
(43) Pub. Date: Oct. 9, 2003

(54) Multiple fault location in a series of devices

(75) Inventors: Alongkorn Kitamorn, Austin, TX (US); Ashwini Kulkarni, Austin, TX (US); Gordon D. McIntosh, Austin, TX (US); Kanisha Patel, Cedar Park, TX (US); Michael Anthony Perez, Cedar Park, TX (US)

Correspondence Address: Duke W. Yee, Carsen, Yee & Cahoon, LLP, P.O. Box 802334, Dallas, TX, 75380, US

(73) Assignee: International Business Machines Corporation, Armonk, NY

(21) Appl. No.: 10/116,522

(22) Filed: Apr. 4, 2002

(51) Int. Cl. G06F 11/07; G06F 11/273

(52) U.S. Cl. 714/5; 714/37

(57) ABSTRACT

A method, computer program product, and data processing system for locating hardware faults occurring in multiple devices in a data processing system is disclosed. The devices have a scanning order in which the devices (or at least information regarding the devices) are scanned to analyze any possible error condition. When a new error is detected in a device, an identification of the device is stored in a data structure. If another error is detected and causes the devices to be scanned again, the scanning process will skip over the device whose identity is stored in the data structure so that the new error can be located.

### BACKGROUND OF THE INVENTION

1. Technical Field

The present invention is related generally to the identification and handling of hardware faults in a data processing system. More specifically, the present invention provides a method, computer program product, and data processing system for identifying and handling multiple errors that occur in a series of devices that are scanned for error diagnosis in a sequential order.

2. Description of Related Art

A logical partitioned (LPAR) functionality within a data processing system (platform) allows multiple copies of a single operating system (OS) or multiple heterogeneous operating systems to be simultaneously run on a single data processing system platform. A partition, within which an operating system image runs, is assigned a non-overlapping subset of the platform's resources. These platform allocable resources include one or more architecturally distinct processors with their interrupt management area, regions of system memory, and I/O adapter bus slots. The partition's resources are represented by the platform's firmware to the OS image.

Each distinct OS or image of an OS running within the platform is protected from each other such that software errors on one logical partition cannot affect the correct operation of any of the other partitions. This is provided by allocating a disjoint set of platform resources to be directly managed by each OS image and by providing mechanisms for ensuring that the various images cannot control any resources that have not been allocated to it. Furthermore, software errors in the control of an operating system's allocated resources are prevented from affecting the resources of any other image. Thus, each image of the OS (or each different OS) directly controls a distinct set of allocable resources within the platform.

With respect to hardware resources in a LPAR system, these resources are shared among various partitions in a mutually-exclusive fashion. That is, a single resource may be allocated to one partition at any one time, but any given resources may allocated to any one of the partitions. This results in each partition behaving as if it were a stand-alone computer. Among the resources that may be shared are input/output (I/O) adapters, random-access memory (RAM), non-volatile random access memory (NVRAM), and hard disk drives, although this list is by no means exhaustive. Each partition within the LPAR system may be booted and shut down over and over without having to cycle the power to the whole system.

Groups of I/O devices may be controlled by a common piece of hardware, such as a host Peripheral Component Interface (PCI) bridge, which may have many I/O adapters controlled or below the bridge. This bridge may be thought of as being shared by all of the partitions that are assigned its slots. Hence, if the bridge becomes inoperable, it affects all of the partitions that share the devices that are below the bridge. Indeed, the problem may be so severe that the whole LPAR system will crash if any partition attempts to further use the bridge. In other words, the entire LPAR system will fail. The normal course of action in this circumstance is to terminate the running partitions that share the bridge. This will keep the system from crashing due to this failure.

What usually occurs is an I/O adapter failure that causes the bridge to assume a non-usable (error) state. At the time of occurrence, the I/O failure invokes a machine check interrupt handler (MCIH), which, in turn, will report the error and then terminate the appropriate partitions. This process is a “normal” solution that prevents the whole LPAR system from crashing due to this problem.

In order to allow the failure to be corrected, it is necessary to identify the particular I/O adapter or I/O adapter slot at which the failure has occurred. This is typically done by sequentially scanning status registers associated with each of the I/O adapters. A problem with this arises, however, when multiple I/O adapters under the control of a single bridge experience errors. If an error first occurs in an adapter that is earlier in the sequence, then an error occurs in an adapter that is later in the sequence, the scanning may stop with the first error and the second error may not be reported. This is because the first error condition cannot be cleared. The reasons why it cannot be cleared is that the error condition must persist for the bridge to remain in a frozen (error) state.

Thus, there exists a need for a method of identifying multiple failures in a series of adapters.

### SUMMARY OF THE INVENTION

The present invention provides a method, computer program product, and data processing system for locating hardware faults occurring in multiple devices (or adapters) in a data processing system. The devices have a scanning order in which the devices (or at least information regarding the devices) are scanned to analyze any possible error condition. When a new error is detected in a device, an identification of the device is stored in a data structure. If another error is detected and causes the devices to be scanned again, the scanning process will skip over the device whose identity is stored in the data structure so that the new error can be located.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of a data processing system in which the present invention may be implemented;

FIG. 2 is a diagram depicting a series of devices (I/O adapters in slots), including a slot experiencing an error, in a data processing system such as that depicted in FIG. 1;

FIG. 3 is a diagram depicting the result of a machine check interrupt handler having detected the error in the series of slots originally depicted in FIG. 2;

FIG. 4 is a diagram depicting the series of slots from FIG. 3 with an additional error condition present in a slot that is subsequent in the scanning order to the slot experiencing the error in FIG. 2;

FIG. 5 is a diagram depicting a series of slots experiencing the same errors as in FIG. 4, but including an additional data structure in accordance with a preferred embodiment of the present invention;

FIG. 6 is a diagram depicting the result of a machine check interrupt handler detecting a second, subsequent error in accordance with a preferred embodiment of the present invention; and

FIG. 7 is a flowchart representation of a process of locating an error in a series of devices in accordance with a preferred embodiment of the present invention.

### DETAILED DESCRIPTION OF THE PREFERRED EMBODIMENT

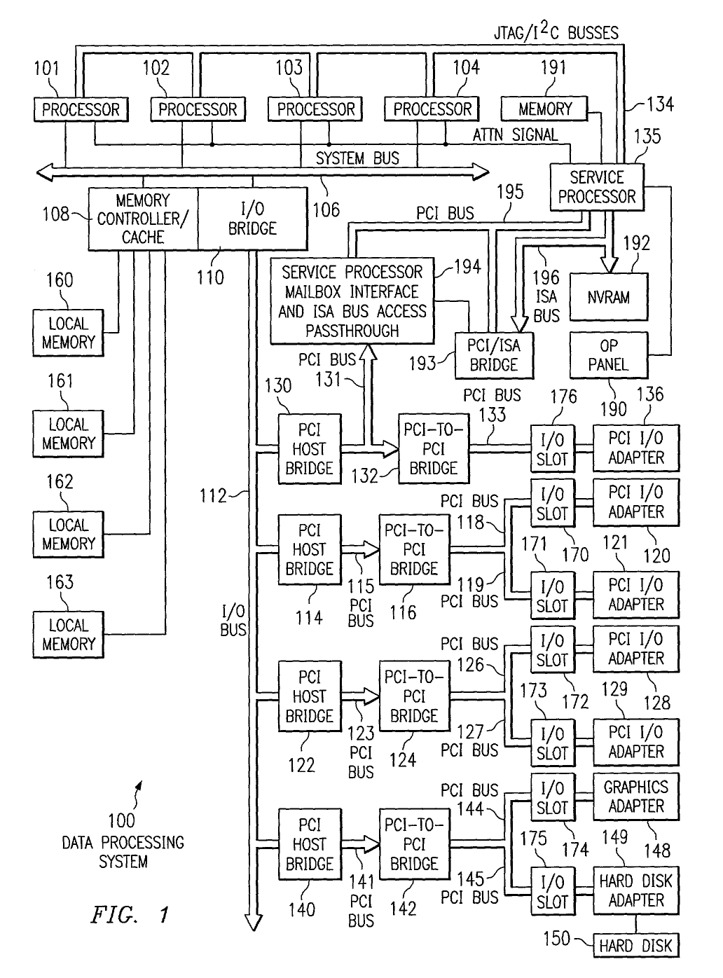

With reference now to the figures, and in particular with reference to FIG. 1, a block diagram of a data processing system in which the present invention may be implemented is depicted. Data processing system 100 may be a symmetric multiprocessor (SMP) system including a plurality of processors 101, 102, 103, and 104 connected to system bus 106. For example, data processing system 100 may be an IBM RS/6000, a product of International Business Machines Corporation in Armonk, N.Y., implemented as a server within a network. Alternatively, a single processor system may be employed. Also connected to system bus 106 is memory controller/cache 108, which provides an interface to a plurality of local memories 160-163. I/O bus bridge 110 is connected to system bus 106 and provides an interface to I/O bus 112. Memory controller/cache 108 and I/O bus bridge 110 may be integrated as depicted.

Data processing system 100 is a logically partitioned data processing system. Thus, data processing system 100 may have multiple heterogeneous operating systems (or multiple instances of a single operating system) running simultaneously. Each of these multiple operating systems may have any number of software programs executing within it. Data processing system 100 is logically partitioned such that different PCI I/O adapters 120-121, 128-129, and 136, graphics adapter 148, and hard disk adapter 149 may be assigned to different logical partitions. In this case, graphics adapter 148 provides a connection for a display device (not shown), while hard disk adapter 149 provides a connection to control hard disk 150.

Thus, for example, suppose data processing system 100 is divided into three logical partitions, P1, P2, and P3. Each of PCI I/O adapters 120-121, 128-129, 136, graphics adapter 148, hard disk adapter 149, each of host processors 101-104, and each of local memories 160-163 is assigned to one of the three partitions. For example, processor 101, local memory 160, and PCI I/O adapters 120, 128, and 129 may be assigned to logical partition P1; processors 102-103, local memory 161, and PCI I/O adapters 121 and 136 may be assigned to partition P2; and processor 104, local memories 162-163, graphics adapter 148 and hard disk adapter 149 may be assigned to logical partition P3.

Each operating system executing within data processing system 100 is assigned to a different logical partition. Thus, each operating system executing within data processing system 100 may access only those I/O units that are within its logical partition. Thus, for example, one instance of the Advanced Interactive Executive (AIX) operating system may be executing within partition P1, a second instance (image) of the AIX operating system may be executing within partition P2, and a Windows 2000 operating system may be operating within logical partition P1. Windows 2000 is a product and trademark of Microsoft Corporation of Redmond, Wash.

Peripheral component interconnect (PCI) host bridge 114 connected to I/O bus 112 provides an interface to PCI local bus 115. A number of PCI input/output adapters 120-121 may be connected to PCI bus 115 through PCI-to-PCI bridge 116, PCI bus 118, PCI bus 119, I/O slot 170, and I/O slot 171. PCI-to-PCI bridge 116 provides an interface to PCI bus 118 and PCI bus 119. PCI I/O adapters 120 and 121 are placed into I/O slots 170 and 171, respectively. Typical PCI bus implementations will support between four and eight I/O adapters (i.e. expansion slots for add-in connectors). Each PCI I/O adapter 120-121 provides an interface between data processing system 100 and input/output devices such as, for example, other network computers, which are clients to data processing system 100.

An additional PCI host bridge 122 provides an interface for an additional PCI bus 123. PCI bus 123 is connected to a plurality of PCI I/O adapters 128-129. PCI I/O adapters 128-129 may be connected to PCI bus 123 through PCI-to-PCI bridge 124, PCI bus 126, PCI bus 127, I/O slot 172, and I/O slot 173. PCI-to-PCI bridge 124 provides an interface between PCI bus 126 and PCI bus 127. PCI I/O adapters 128 and 129 are placed into I/O slots 172 and 173, respectively. In this manner, additional I/O devices, such as, for example, modems or network adapters may be supported through each of PCI I/O adapters 128-129. In this manner, data processing system 100 allows connections to multiple network computers.

A memory mapped graphics adapter 148 inserted into I/O slot 174 may be connected to I/O bus 112 through PCI bus 144, PCI-to-PCI bridge 142, PCI bus 141 and host bridge 140. Hard disk adapter 149 may be placed into I/O slot 175, which is connected to PCI bus 145. In turn, this bus is connected to PCI-to-PCI bridge 142, which is connected to PCI Host Bridge 140 by PCI bus 141.

A PCI host bridge 130 provides an interface for a PCI bus 131 to connect to I/O bus 112. PCI I/O adapter 136 is connected to I/O slot 176, which is connected to PCI-to-PCI bridge 132 by PCI bus 133. PCI-to-PCI bridge 132 is connected to PCI bus 131. This PCI bus also connects PCI host bridge 130 to the service processor mailbox interface and ISA bus access pass-through logic 194 and PCI-to-PCI bridge 132. Service processor mailbox interface and ISA bus access pass-through logic 194 forwards PCI accesses destined to the PCI/ISA bridge 193. NVRAM storage 192 is connected to the ISA bus 196. Service processor 135 is coupled to service processor mailbox interface and ISA bus access pass-through logic 194 through its local PCI bus 195. Service processor 135 is also connected to processors 101-104 via a plurality of JTAG/I²C busses 134. JTAG/I²C busses 134 are a combination of JTAG/scan busses (see IEEE 1149.1) and Phillips I²C busses. However, alternatively, JTAG/12C busses 134 may be replaced by only Phillips I²C busses or only JTAG/scan busses. All SP-ATTN signals of the host processors 101, 102, 103, and 104 are connected together to an interrupt input signal of the service processor. The service processor 135 has its own local memory 191, and has access to the hardware OP-panel 190.

When data processing system 100 is initially powered up, service processor 135 uses the JTAG/scan I²C busses 134 to interrogate the system (host) processors 101-104, memory controller/cache 108, and I/O bridge 110. At completion of this step, service processor 135 has an inventory and topology understanding of data processing system 100. Service processor 135 also executes Built-In-Self-Tests (BISTs), Basic Assurance Tests (BATs), and memory tests on all elements found by interrogating the host processors 101-104, memory controller/cache 108, and I/O bridge 110. Any error information for failures detected during the BISTs, BATs, and memory tests are gathered and reported by service processor 135.

If a meaningful/valid configuration of system resources is still possible after taking out the elements found to be faulty during the BISTs, BATs, and memory tests, then data processing system 100 is allowed to proceed to load executable code into local (host) memories 160-163. Service processor 135 then releases the host processors 101-104 for execution of the code loaded into host memory 160-163. While the host processors 101-104 are executing code from respective operating systems within the data processing system 100, service processor 135 enters a mode of monitoring and reporting errors. The type of items monitored by service processor 135 include, for example, the cooling fan speed and operation, thermal sensors, power supply regulators, and recoverable and non-recoverable errors reported by processors 101-104, local memories 160-163, and I/O bridge 110. Service processor 135 is responsible for saving and reporting error information related to all the monitored items in data processing system 100. Service processor 135 also takes action based on the type of errors and defined thresholds. For example, service processor 135 may take note of excessive recoverable errors on a processor's cache memory and decide that this is predictive of a hard failure. Based on this determination, service processor 135 may mark that resource for deconfiguration during the current running session and future Initial Program Loads (IPLs). IPLs are also sometimes referred to as a “boot” or “bootstrap”.

Data processing system 100 may be implemented using various commercially available computer systems. For example, data processing system 100 may be implemented using IBM eServer iSeries Model 840 system available from International Business Machines Corporation. Such a system may support logical partitioning using an OS/400 operating system, which is also available from International Business Machines Corporation.

Those of ordinary skill in the art will appreciate that the hardware depicted in FIG. 1 may vary. For example, other peripheral devices, such as optical disk drives and the like, also may be used in addition to or in place of the hardware depicted. The depicted example is not meant to imply architectural limitations with respect to the present invention.

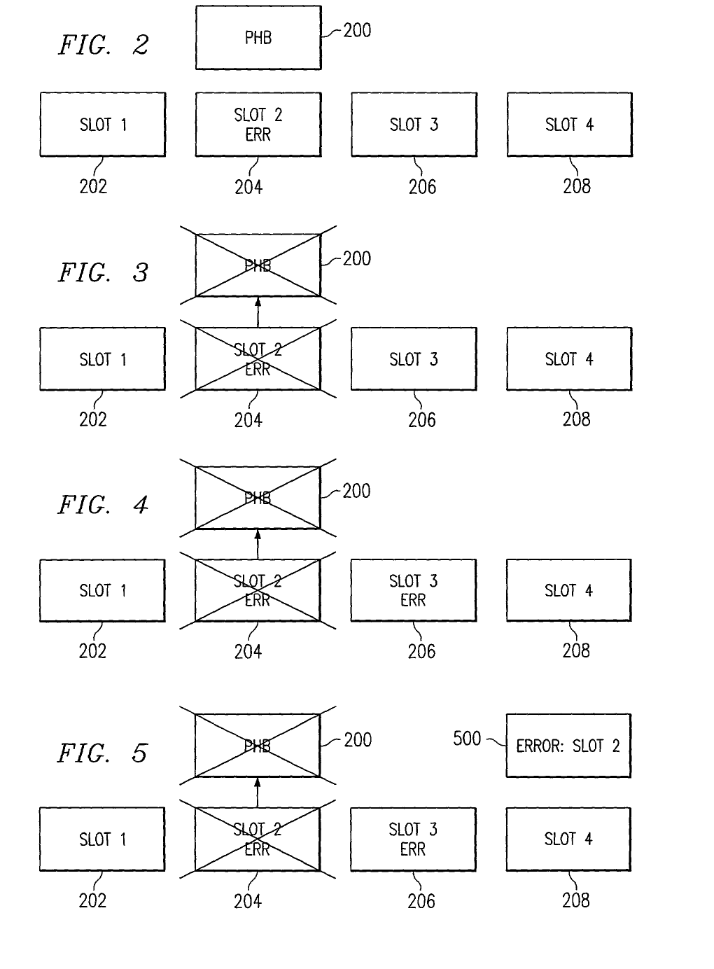

The present invention provides a method, computer program product, and data processing system for locating faults within a series of devices having a scanning order for locating errors. FIG. 2 is a diagram depicting a series of devices having a scanning order in a data processing system such as that depicted in FIG. 1. A PCI host bridge 200 handles I/O transactions with devices in slots 202, 204, 206, and 208. The adapter in slot 204 is experiencing an error. In order to address the error situation occurring in slot 204, the machine check interrupt handler must locate the error. Typically, the machine check interrupt handler must locate the error by scanning status registers associated with each of slots 202, 204, 206, and 208 according to a pre-determined scanning order (in this example, the order is from left to right). The status registers may be contained within an I/O bridge, such as I/O bridge 110 in FIG. 1, a PCI host bridge, such as PCI host bridge 200 or within the adapters themselves, such as the adapters in slots 202, 204, 206, and 208.

To locate the error occurring in the adapter in slot 204, the machine check interrupt handler will first examine the status register associated with slot 202. Seeing that there is no error occurring in the adapter in slot 202, the machine check interrupt handler will progress in its search to slot 204, which is the next slot in sequence. As slot 204 contains an adapter that is experiencing an error, the machine check interrupt handler will identify slot 204 as experiencing a failure, as depicted in FIG. 3 as being “crossed out.” Identifying the error occurring in adapter in slot 204 will result in PCI host bridge 200 being placed in an error state, as depicted in FIG. 3 as being “crossed out.” The machine check interrupt handler will then terminate the error locating process.

PCI host bridge 200 must remain in an error state until the problem with slot 204 is corrected, to avoid crashing the system. As a result, slot 204 cannot be cleared of its error status. One consequence of this is that if an additional error occurs in an adapter that is in a slot further along in the scanning order, the additional error may not be identified. For example, FIG. 4 shows the adapter in slot 206 experiencing an error. Because slot 204 also contains an adapter that is experiencing an error, the machine check interrupt handler will examine the status register for slot 202, then examine the status register for slot 204, and finding an error condition in the adapter in slot 204, will terminate the error-locating process before ever reaching slot 206.

The present invention remedies this situation by introducing an additional data structure, such as data structure 500 depicted in FIG. 5. In a preferred embodiment, data structure 500 is recorded in a memory device such as NVRAM storage 192 in FIG. 1. Data structure 500 acts as a log, recording errors as they are identified by the machine check interrupt handler. As the error occurring in the adapter in slot 204 has already been detected in FIG. 5, data structure 500 shows an error occurring in that slot. In a preferred embodiment of the present invention, when the machine check interrupt handler next scans slots 202, 204, 206, and 208, it will first examine the status register associated with slot 202, then examine the status register associated with slot 204. When the machine check interrupt handler reaches slot 204, however, it will search data structure 500 for a record of the error occurring at slot 204. When the machine check interrupt handler sees that the error occurring at slot 204 has already been recorded in data structure 500, the machine check interrupt handler will examine the status register associated with slot 206. As shown in FIG. 6, the error occurring at slot 206 will be identified, and data structure 500 will be updated to include the newly discovered error.

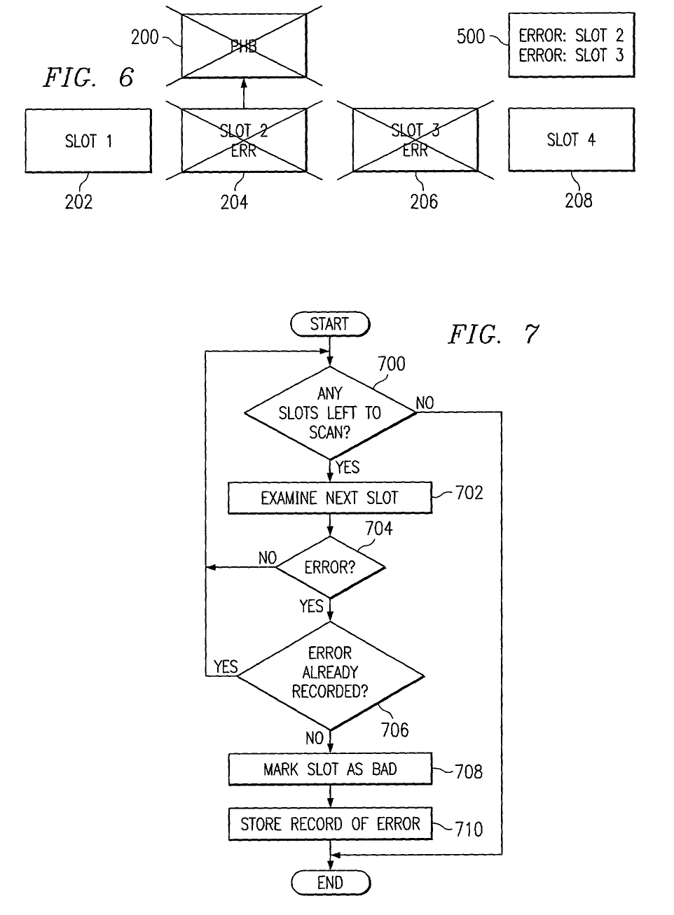

FIG. 7 is a flowchart representation of a process of locating faults within a series of devices in accordance with a preferred embodiment of the present invention. In a preferred embodiment, the errors occurred in I/O adapters contained in a series of slots. One of ordinary skill in the art, however, will recognize that any set of devices occurring in a series having a discernible order can be scanned for errors using the process described here in FIG. 7. The process is not limited to the preferred embodiment.

First, a determination is made as to whether all the slots have already been scanned (step 700). If not—that is, if any slots have yet to be scanned for errors—the status register associated with the next slot in sequence is examined (step 702). A determination is then made as the whether an error has occurred at that slot (step 704). If not, the process cycles to step 700 to examine the next slot, if any. If an error has occurred, a determination is then made as to whether the error has already been recorded in an appropriate data structure such as data structure 500 in FIG. 5 (step 706). If the error has already been recorded, the process cycles to step 700 to examine the next slot, if any. If the error has not been recorded, however, then the slot is identified as experiencing an error (step 708), and a record of the error is stored in an appropriate data structure such as data structure 500 in FIG. 5 (step 710). After step 710, the process terminates. Alternatively, the process may end if at step 700 there are no more slots to scan.

It is important to note that while the present invention has been described in the context of a fully functioning data processing system, those of ordinary skill in the art will appreciate that the processes of the present invention are capable of being distributed in the form of a computer readable medium of instructions or other functional descriptive material and in a variety of other forms and that the present invention is equally applicable regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system. Functional descriptive material is information that imparts functionality to a machine. Functional descriptive material includes, but is not limited to, computer programs, instructions, rules, facts, definitions of computable functions, objects, and data structures.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method comprising:
detecting an error in a first device from a plurality of devices, wherein the plurality of devices is associated with a scanning order; and
scanning information regarding the plurality of devices in the scanning order to identify the first device, skipping over each device that is identified in a data structure.

2. The method of claim 1, wherein the data structure is stored in a supervisory device in communication with the plurality of devices.

3. The method of claim 2, further comprising:
in response to detecting the error, disabling the supervisory device at least in part.

4. The method of claim 1, further comprising:
inserting an identity of the first device in the data structure.

5. The method of claim 1, wherein the plurality of devices includes at least one integrated circuit.

6. The method of claim 5, wherein the at least one integrated circuit includes at least one input/output interface integrated circuit.

7. The method of claim 1, wherein the plurality of devices includes at least one peripheral component in a data processing system.

8. The method of claim 1, wherein scanning information regarding the plurality of devices comprises:
examining error registers in an interface circuit, wherein each error register represents a status of an associated device from the plurality of devices.

9. The method of claim 1, wherein scanning information regarding the plurality of devices comprises:
analyzing behavior of a current device in the scanning order from the plurality of devices to determine a current status of the current device.

10. A computer program product in a computer-readable medium comprising functional descriptive material that, when executed by a computer, enables the computer to perform acts including:
detecting an error in a first device from a plurality of devices, wherein the plurality of devices is associated with a scanning order; and
scanning information regarding the plurality of devices in the scanning order to identify the first device, skipping over each device that is identified in a data structure.

11. The computer program product of claim 10, wherein the data structure is stored in a supervisory device in communication with the plurality of devices.

12. The computer program product of claim 11, comprising additional functional descriptive material that, when executed by the computer, enables the computer to perform additional acts including:
in response to detecting the error, disabling the supervisory device at least in part.

13. The computer program product of claim 10, comprising additional functional descriptive material that, when executed by the computer, enables the computer to perform additional acts including:
inserting an identity of the first device in the data structure.

14. The computer program product of claim 10, wherein the plurality of devices includes at least one integrated circuit.

15. The computer program product of claim 14, wherein the at least one integrated circuit includes at least one input/output interface integrated circuit.

16. The computer program product of claim 10, wherein the plurality of devices includes at least one peripheral component in a data processing system.

17. The computer program product of claim 10, wherein scanning information regarding the plurality of devices comprises:
examining error registers in an interface circuit,
wherein each error register represents a status of an associated device from the plurality of devices.

18. The computer program product of claim 10, wherein scanning information regarding the plurality of devices comprises:
analyzing behavior of a current device in the scanning order from the plurality of devices to determine a current status of the current device.

19. A data processing system comprising:
at least one processor;
memory in communication with the at least one processor;
a plurality of devices in communication with the at least one processor and having a scanning order; and
a set of instructions in the memory,
wherein the at least one processor executes the set of instructions to perform acts including:
detecting an error in a first device from a plurality of devices, wherein the plurality of devices is associated with a scanning order; and
scanning information regarding the plurality of devices in the scanning order to identify the first device, skipping over each device that is identified in a data structure.

20. The data processing system of claim 19, wherein the data structure is stored in a supervisory device in communication with the plurality of devices.

21. The data processing system of claim 20, wherein the at least one processor executes the set of instructions to perform additional acts including:
in response to detecting the error, disabling the supervisory device at least in part.

22. The data processing system of claim 19, wherein the at least one processor executes the set of instructions to perform additional acts including:
inserting an identity of the first device in the data structure.

23. The data processing system of claim 19, wherein the plurality of devices includes at least one integrated circuit.

24. The data processing system of claim 23, wherein the at least one integrated circuit includes at least one input/output interface integrated circuit.

25. The data processing system of claim 19, wherein the plurality of devices includes at least one peripheral component in a data processing system.

26. The data processing system of claim 19, wherein scanning information regarding the plurality of devices comprises:
examining error registers in an interface circuit, wherein each error register represents a status of an associated device from the plurality of devices.

27. The data processing system of claim 19, wherein scanning information regarding the plurality of devices comprises:
analyzing behavior of a current device in the scanning order from the plurality of devices to determine a current status of the current device.
